(19) United States
(12) Patent Application Publication
(10) Pub. No.: US 2015/0249712 A1
(43) Pub. Date: Sep. 3, 2015

(54) METHOD AND SYSTEM ENABLING THE INTERACTION OF VIRTUAL MACHINES HOSTED BY HETEROGENEOUS VIRTUALIZATION SYSTEMS

(71) Applicants: EUROPEAN AERONAUTIC DEFENCE AND SPACE COMPANY EADS FRANCE, Paris (FR); CASSIDIAN CYBERSECURITY SAS, Elancourt (FR)

(72) Inventors: Philippe Biondi, Saint-Cloud (FR); Charles Prost, Montigny Le Bretonneux (FR)

(21) Appl. No.: 14/438,604

(22) PCT Filed: Oct. 25, 2013
(86) PCT No.: PCT/EP2013/072375

§ 371 Date: Apr. 24, 2015

(30) Foreign Application Priority Data
Oct. 26, 2012 (FR) 12 60210

(51) Int. Cl. H04L 29/08; G06F 9/455; H04L 12/723

(52) U.S. Cl. CPC H04L 67/141; H04L 45/50; G06F 9/45558; G06F 2009/45595

(57) ABSTRACT

A communication method for enabling the interaction of at least two virtual machines hosted by heterogeneous virtualization solutions. Network streams from interfaces of the virtual machines are encapsulated and redirected on a physical device comprising at least one processor and one memory. The physical device de-encapsulates the network streams and establishes a link between the network streams. A communication system enables the interaction of at least two virtual machines hosted by heterogeneous virtualization systems.

### FIELD OF INVENTION

The present invention pertains to the field of Information Technologies, and especially to the field of virtualization.

The present invention pertains more particularly to a method and to a system allowing the interaction of virtual machines hosted by heterogeneous virtualization solutions.

The method according to the present invention allows virtual machines, hosted by heterogeneous virtualization solutions which are a priori mutually incompatible, to communicate at the network level, thus ignoring the underlying virtualization mechanisms.

### PRIOR ART

With a view to deploying a simulation platform which is independent of the virtualization solutions used, it is necessary to have a mechanism allowing virtual machines, hosted by various virtualization solutions, to communicate with one another.

Indeed, if it suffices to support a single virtualization solution, then this need is already satisfied in the majority of cases. However, using a single virtualization solution may endanger the future of the platform in case support for said solution should be stopped.

The issue at stake is therefore to ensure the future of such a platform by rendering it independent of the virtualization solutions used.

The already existing solutions (such as the Hynesim project (http://www.hynesim.org) make do with supporting certain virtualization solutions but not all. In the case where several are supported, they must be of a very particular type (type-2, so-called “hosted”, hypervisor).

The technical solution afforded is then the use of a “distributed switch”, such as the VDE project (http://vde.sourceforge.net). This solution then allows virtual machines hosted by different type-2 virtualization solutions to communicate with one another. On the other hand, any virtual machine hosted by a type-1 virtualization solution (so-called “native”, such as VMware ESXi for example) will not be able to communicate readily with the previous machines.

### SUMMARY OF THE INVENTION

The present invention intends to remedy the drawbacks of the prior art by proposing a method allowing the interaction of virtual machines hosted by heterogeneous virtualization solutions.

For this purpose, the present invention relates, in its most general acceptation, to a communication method allowing the interaction of at least two virtual machines hosted by heterogeneous virtualization solutions, characterized in that it comprises the following steps:

encapsulation of network streams originating from interfaces of said virtual machines;

redirection of said network streams onto a physical device comprising at least one processor and a memory;

de-encapsulation of said network streams by said physical device; and

establishment by said physical device of a link between said network streams.

The advantages of the method according to the present invention are the ignoring of the virtualization solution which dispatches the network stream (it matters little whether it be a type-1 or type-2 virtualization solution) as well as the capacity to easily manage the networking on the third-party physical device, since it is readily configurable.

According to one embodiment, the encapsulation of the network streams is carried out with the aid of multiprotocol label switching (MPLS) technology.

According to another embodiment, the encapsulation of the network streams is carried out with the aid of virtual local area network (VLAN) technology (IEEE 802.1Q).

Advantageously, said network streams are redirected toward said physical device by means of an ad hoc configured switch.

Preferably, each of said network streams is identified in a unique manner by means of an identifier.

According to a variant, said encapsulation of said network streams is carried out in a centralized manner.

According to another variant, said encapsulation of said network streams is carried out for each virtualization solution.

The present invention also pertains to a communication system allowing the interaction of at least two virtual machines hosted by heterogeneous virtualization solutions, characterized in that it comprises means for:

encapsulating network streams originating from interfaces of said virtual machines;

redirecting said network streams onto a physical device comprising at least one processor and a memory;

de-encapsulating said network streams by means of said physical device; and

establishing by means of said physical device a link between said network streams.

### BRIEF DESCRIPTION OF THE DRAWINGS

The invention will be better understood with the aid of the description, given hereinafter purely by way of explanation, of an embodiment of the invention, with reference to the Figures in which:

FIG. 1 illustrates the various steps of the method according to the present invention; and

FIG. 2 represents the system according to the present invention in an embodiment.

### DETAILED DESCRIPTION OF THE EMBODIMENTS OF THE INVENTION

The communication method according to the present invention allows the interaction of at least two virtual machines 10, 11 hosted by heterogeneous virtualization solutions.

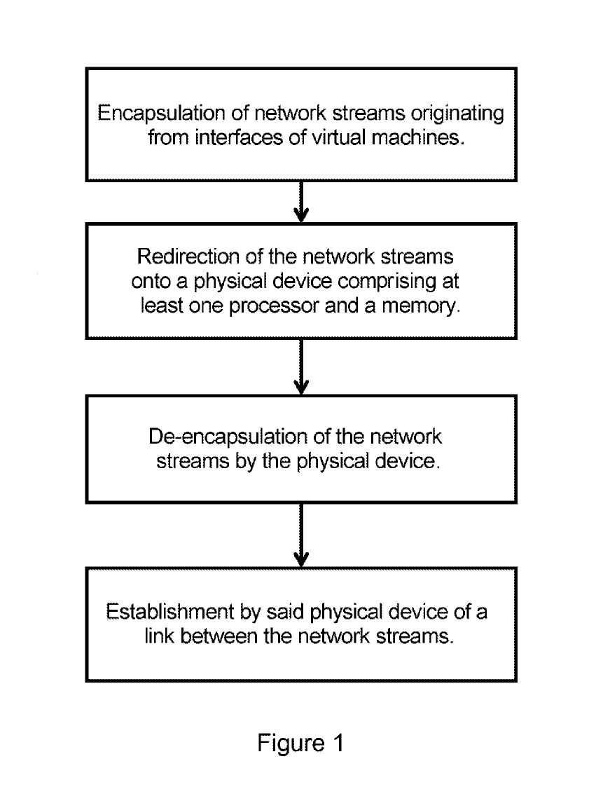

FIG. 1 illustrates the various steps of the method according to the present invention:

encapsulation of network streams 30, 31 originating from interfaces 20, 21 of said virtual machines 10, 11;

redirection of said network streams 30, 31 onto a physical device 40 comprising at least one processor 41 and a memory 42;

de-encapsulation of said network streams 30, 31 by said physical device 40;

and

establishment by said physical device 40 of a link between said network streams 30, 31.

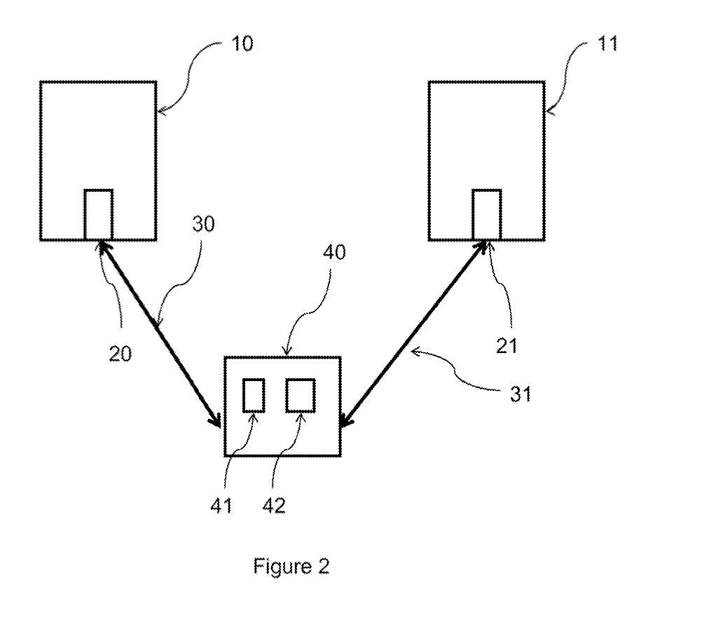

FIG. 2 represents the system according to the present invention in an embodiment. The communication system 60 according to the present invention allows the interaction of at least two virtual machines 10, 11 hosted by heterogeneous virtualization solutions. This communication system 60 comprises means for:

encapsulating network streams 30, 31 originating from interfaces 20, 21 of said virtual machines 10, 11;

redirecting said network streams 30, 31 onto a physical device 40 comprising at least one processor 41 and a memory 42;

de-encapsulating said network streams 30, 31 by means of said physical device 40; and

establishing by means of said physical device 40 a link between said network streams 30, 31.

The solution according to the present invention consists in encapsulating the network stream 30, 31 originating from each interface 20, 21 of each virtual machine 10, 11, whatever its virtualization solution, and to redirect it onto a third-party physical device (or machine) 40 which will be in charge of effecting the link between the various network streams 30, 31.

Indeed, each virtualization solution (or the operating system where it is installed) allows this encapsulation of the network stream 30, 31 of a virtual interface. By exploiting this very widespread property among available virtualization solutions, it is thus possible to recover all the network streams 30, 31 on a third-party physical device 40 which will be in charge of the link between the network streams 30, 31.

Customarily, the networking of the various streams is performed on one of the virtualization solutions if they are homogeneous. The use of heterogeneous virtualization solutions prevents this networking in the conventional manner. Encapsulating the network streams and leaving the responsibility for networking to a mastered third-party physical device is an innovative solution.

The advantages of the method according to the present invention are the ignoring of the virtualization solution which dispatches the network stream 30, 31 (it matters little whether it be a type-1 or type-2 virtualization solution) as well as the capacity to easily manage the networking on the third-party physical device 40, since it is readily configurable.

The encapsulation of the network streams 30, 31 on each virtualization solution can be effected with the aid of several technologies, such as for example the MPLS or VLAN technologies (IEEE norm 802.1Q).

In one embodiment, all the encapsulated network streams 30, 31 are redirected, via an ad hoc configured switch 50, toward the third-party physical device 40 which undertakes the de-encapsulation of each network stream 30, 31 and interlinks them, as a function of the desired network disposition.

In one embodiment, each stream 30, 31 is identified in a unique manner on the scale of the platform, by an identifier, for example the VLAN ID identifier (unique throughout the platform) if VLAN technology is used. According to a variant, the encapsulation is carried out in a centralized manner so as to avoid conflicts and the breakage of the partitioning.

The delegation of the management of the virtual network to a third-party physical device 40 makes it possible to manage much more finely the representation of a real network, of its constraints and of its limitations. By virtue of the method according to the present invention, certain characteristics of the network, such as latency or possible loss of packets, will be represented more precisely.

A variant can consist in linking the virtualization solutions directly to the third-party physical device 40 without passing through a switch. Uniqueness of encapsulation of the streams is then required only for each virtualization solution rather than on the scale of the platform as a whole.

This variant also makes it possible to remove the drawback of the saturation of the network linkup running to the third-party physical device. On the other hand, it makes it obligatory to deploy a physical network interface on the third-party physical device for each virtualization solution used.

The present invention makes it possible to acquire a certain independence in relation to the virtualization solutions, insofar as it makes it possible to implement various heterogeneous virtualization solutions.

The invention is described in the foregoing by way of example. It is understood that the person skilled in the art is able to achieve different variants of the invention without however departing from the scope of the patent.

1-7. (canceled)

8. A communication method for enabling an interaction of at least two virtual machines hosted by heterogeneous virtualization solutions, comprising the steps of:
encapsulating network streams originating from interfaces of the virtual machines in a centralized manner;
redirecting the network streams onto a physical device comprising at least one processor and a memory;
de-encapsulating the network streams by the physical device; and
establishing a link between the network streams by the physical device

9. The communication method as claimed in claim 8, further comprising the step of encapsulating the network streams with an aid of a multiprotocol label switching (MPLS) technology.

10. The communication method as claimed in claim 8, further comprising the step of encapsulating the network streams with an aid of a virtual local area network (VLAN) technology conforming to IEEE 802.1Q standard.

11. The communication method as claimed in claim 8, further comprising the step of redirecting the network streams toward the physical device by an ad hoc configured switch.

12. The communication method as claimed in claim 8, further comprising the step of identifying each network stream with a unique identifier.

13. The communication method as claimed in claim 8, further comprising the step of encapsulating the network streams for each heterogeneous virtualization solution.

14. A communication system for enabling an interaction of at least two virtual machines hosted by heterogeneous virtualization solutions, comprising:
an interface, associated with each virtual machine, originates a network stream which is encapsulated in a centralized manner; and
a physical device, comprising at least one processor and a memory, receives the encapsulated network streams, de-encapsulates the encapsulated network streams, and establishes a link between the network streams.
